(19) United States
(12) Patent Application Publication
(10) Pub. No.: US 2021/0046578 A1
(43) Pub. Date: Feb. 18, 2021

(54) APPARATUS FOR RESISTANCE WELDING

(71) Applicants: Gary Thomas Osborne, Indianapolis, IN (US); Tobias Maxwell Walsman, Batesville, IN (US)

(72) Inventors: Gary Thomas Osborne, Indianapolis, IN (US); Tobias Maxwell Walsman, Batesville, IN (US)

(21) Appl. No.: 16/989,361

(22) Filed: Aug. 10, 2020

Related U.S. Application Data
(60) Provisional application No. 62/885,806, filed on Aug. 12, 2019.

(51) Int. Cl. B23K 11/11; B23K 11/30; B23K 11/31; B23K 11/36

(52) U.S. Cl. CPC B23K 11/11; B23K 11/362; B23K 11/31; B23K 11/3009

(57) ABSTRACT

An apparatus includes a welding electrode and a holder with a primary electrical connection for carrying a welding current. The electrode and the holder may separate easily due to a weak interference fit of the primary electrical connection. Bare hands may provide sufficient force for separation. The electrode and the holder may be configured for self-alignment. A quick-release mechanism may prevent unintentional dislodgement of the electrode from the holder and include a rotation-resistant device for preventing electrode rotation. A secondary electrical connection may be included to supplement or replace the primary electrical connection. A workpiece clamping force, traditionally intended for clamping the electrode to a workpiece, may also be utilized to enable the secondary electrical connection.

### CROSS-REFERENCE TO RELATED APPLICATIONS

This application claims the benefit of, and incorporates by reference for all purposes, U.S. provisional application No. 62/885,806, filed Aug. 12, 2019, entitled WELDING ELECTRODE WITH HOLDER.

### RELATED CO-PENDING U.S. PATENT APPLICATIONS

Not applicable.

### COPYRIGHT NOTICE

Not applicable.

### BACKGROUND OF THE RELEVANT PRIOR ART

One or more embodiments of the invention generally relate to electrodes or holders for resistance welding. More particularly, certain embodiments of the invention relate to electrodes and holders with changeable electrode tips.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is U.S. Pat. No. 7,060,929 to Sun et al describing a spot-welding apparatus 10 (a welding machine) which has an electrode 28 that makes physical contact with a sheet 14 (a workpiece) to create a weld nugget 24. Above the workpiece is an electrode holder 32 that supports the electrode and binds it to the welding machine. Below the workpiece is a lower holder 30 that binds a stationary electrode 26 to the welding machine. The welding machine provides a workpiece clamping force that squeezes the workpiece between the two electrodes. It improves reliability of the physical contact enabling the welding machine to send an electrical welding current through the electrodes into the workpiece to heat the workpiece and form the weld nugget. The stationary electrode applies a counter force that opposes the workpiece clamping force and holds the workpiece and the electrodes in a static condition while the weld nugget is made. The welding machine has a welding schedule that controls the workpiece clamping force, as shown in Sun's FIG. 2. A reverse schedule may also exist to control an extracting force that withdraws the electrode from the workpiece. The two schedules may, or may not, be similar regarding the applied forces' absolute values and timings.

Another example is U.S. Pat. No. 6,011,237 to Yang which describes a contact tip locking mechanism designed to self-lock through repeated resistance spot welding. It has an electrode shank 10 (holder) having a top 14 with a metal pin 16 that serves as an anchor point for an electrode 18. Lead-in notches 20 and diagonal grooves 22 on both sides of the electrode allow the electrode to be locked onto the holder. Rotation of the electrode in one direction may tighten the lock while rotation in the opposite direction may loosen it. The metal pin needs a high strength alloy material to withstand repeated impacts of the workpiece clamping force.

Another example is a demonstration video published Oct. 2, 2008 which shows an electrode for a spot-welder (welding machine) in the left hand, an electrode clamp above the electrode, and a screw handle in the right hand. This video shows the right hand turning the screw handle and releasing the electrode from the clamp.

Another example is Patent CN2259256Y from The Patent Office of the People's Republic of China, published Oct. 13, 1997. It describes a main body 1 (welding electrode) having a connection body 2 (holder), an electrode head 3 (base), and a screw 4. The electrode and the holder have self-holding tapers binding them into an assembly which is attached to the base by the screw. Two steps may be followed to change the electrode. In the first step, the screw may be removed detaching the assembly from the base. In the second step, gripping tools may be utilized to separate the electrode from the holder.

Another example is U.S. Pat. No. 5,387,774 to Boyer et al. which describes upper and lower welding caps 3 bound to electrode bodies 1 by tapers. Brazing rings 5 are utilized to attach upper and lower contact tips 4 to the welding caps, respectively. Removal of the contact tips may be accomplished by stopping the circulation of a water coolant, inserting a resistive metal sheet between the contact tips, and adjusting the welding current to melt the brazing rings. Since the welding current may be AD, DC, or a combination of both, the welding schedule may also need adjustment.

Another example is U.S. Pat. No. 5,726,420 to Lajoie which describes a welding gun with a contact tip having a threaded portion, a tapered portion, an extension portion, and a gripping feature. The tip has a wire feed hole extending through its length. The threaded portion fastens to a nozzle which has matching threads. Usage of a liquid coolant is not indicated. The contact tip may be incompatible due to liquid leakage through the wire feed hole or the threaded portion.

Welding machines, in general, may have a pump and a chiller (refrigeration system) for the liquid coolant. The pump circulates the coolant from the chiller, to the electrodes and/or holders, and back to the chiller with the objective of preventing overheating. Despite the coolant, the components may be heated while welding and cooled while idle. This hot/cool cycling may strengthen the self-holding tapers making the electrodes more difficult to detach.

Another example is U.S. Pat. No. 9,566,660 to Holzhauer which describes an electrode cap 5 attached to a holder 2 by an interference fit. A thin edge 15 of the cap 5 is forced into an associated receiving recess 16 on the holder 2 side by reducing.

Another example is a resistance Welding Catalog published in 2017. Pages 8 and 9 show welding caps and shanks. Electrodes manufactured in this style generally are bound to holders by various self-holding tapers which include standard designations such as 4RW, 5RW, 6RW, 7RW, 4CT, 5CT, 6CT, or 7CT. Drawings of the tapers are shown in a Taper Chart which does not indicate a publish date although it may be prior to 2017.

Another example is the resistance Welding Catalog, pages 28 and 29, which show various high-pressure tips for resistance welding for workpiece clamping force greater than 2000 pounds. A high-pressure tip (electrode) has a flat, surface for making an electrical connection with a holder having a flat, tip-facing surface and a hole for the liquid coolant. In a normal mode of operation for prior-art devices, the electrode is supported in the holder by a threaded coupling. The threaded coupling binds the electrode to the holder and may render the workpiece clamping force irrelevant regarding the electrical connection.

The threaded coupling may have an abnormal mode of operation for prior-art devices which is not shown in the catalog. In that mode, the electrode is still supported by the holder, but it may move relative to the holder because the threaded coupling is loose. The electrode may float up and down or it may rotate. This may be caused by negligence (someone forgot to tighten the threaded coupling) or misuse (the threaded coupling was not sufficiently tightened). The movement of the electrode may be most apparent while the workpiece clamping force is not applied. The abnormal mode of operation may be dangerous as the threaded coupling may continue to loosen during operation of the welding machine and the electrode may dislodge from the holder unintentionally.

Another example is shown on page 2 of a Machine Taper webpage which describes a self-holding taper class which is capable of withstanding drilling forces without a drawbar. It also describes self-releasing tapers as not staying together without a drawbar. The publish date of this information is not shown but it may be prior to 2017.

Another example is a training video Sep. 10, 2012 which shows a welding machine with a resistance welding electrode in need of replacement. It is worn or misshaped from use. An area of contact with the workpiece may have increased in size causing inferior weld quality. Greater welding current may be produced straining the welder's electrical components. If not changed, the worn electrode may contribute to a premature failure of the welding machine.

An operator of the welder machine may remove the electrode with gripping tools. One method of removal, shown in the video, includes griping the holder with one tool, griping the electrode with another tool, and rotating the electrode back and forth with a twisting motion. The rotations break a physical connection of self-locking tapers that bind the electrode to the holder. Substantial physical effort may be required as shown. The worn electrode and the holder may be replaced after the old components are removed.

The replaced electrode and holder may require alignment. The video demonstrates an alignment method that includes careful adjustment and verification. It shows a workpiece having acceptable-quality spot welds and an inferior-quality spot weld. This training may be required to instruct welding machine operators on proper replacement and alignment of the electrode and the holder. Maintaining proper alignment is an unresolved problem in resistance welding. Despite adequate training, operator negligence or error may lead to misalignment, poor quality, and scrapped workpieces.

The welding machine cannot be used while the electrodes are being replaced. The repair period may be referred to as maintenance downtime. It can be costly for the following reasons. More downtimes and longer downtime decrease the number of workpieces that can be welded (and sold) in a given period of time. Other non-welding machinery may cease production during the downtime. Additional welders and operators may be required to lessen the impact of downtime.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an exploded side view of the invention.

FIG. 1A is a top view of the invention.

FIG. 2 is a side view of the invention assembled with cut-away sections.

FIG. 3 is a side view of the invention during disassembly.

FIG. 4 is a disassembled side view of the invention with exaggerated features for illustration.

FIG. 5 is an assembled side view of the invention with exaggerated features for illustration.

FIG. 6 is an exploded side view of an alternate embodiment of the invention.

FIG. 7 is an assembled side view of the FIG. 6 embodiment in which the holder has a cut-away section.

FIG. 8 is an exploded side view of another embodiment of the invention.

FIG. 8A is a top view of the FIG. 8 embodiment without the electrode.

FIG. 9 is an assembled side view of the FIG. 8 embodiment.

FIG. 10 is a 3-dimensional perspective view of the FIG. 8 holder.

FIG. 11 is a cross-sectioned side view of the FIG. 8 holder rotated 90 degrees.

FIGS. 12 and 13 are top views of variations of the FIG. 8 holder.

FIG. 14 is an exploded side view of another embodiment of the invention.

FIG. 15 is a cross-sectioned side view of the FIG. 14 holder rotated 90 degrees.

FIG. 15A is an assembled side view of the FIG. 14 embodiment.

FIG. 16 is an exploded side view of another embodiment of the invention.

FIG. 17 is an exploded side view of the FIG. 16 embodiment rotated 90 degrees.

FIG. 18 is an assembled side view of the FIG. 16 embodiment.

FIG. 19 is a side view of another embodiment of the invention.

FIG. 20 is an exploded side view of another embodiment of the invention.

FIG. 21 is an exploded side view of the FIG. 20 embodiment rotated 90 degrees.

FIG. 22 is an assembled side view of the FIG. 14 embodiment.

FIG. 23 is a schematic diagram of an electrical model of the invention.

FIG. 24 is an exploded side view of another embodiment of the invention.

FIG. 25 is an assembled side view of the FIG. 24 embodiment.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the drawings. Those skilled in the art will appreciate that the detailed description given is for explanatory purposes as the invention extends beyond these limited embodiments. For example, it should be appreciated that those skilled in the art will, in light of the teachings of the present invention, recognize many alternate and suitable approaches, depending upon the needs of various applications, to implement the functionality of any given detail described, beyond the embodiments described. Modifications and variants of the invention that are too numerous to be listed. Also, singular words should be read as plural and vice versa and masculine as feminine and vice versa, where appropriate, and alternative embodiments do not necessarily imply that the two are mutually exclusive.

The present invention is not limited to the methodology, compounds, materials, manufacturing techniques, uses, and applications, described, as these may vary. The terminology used is for describing embodiments and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all terms have the same meanings as commonly understood by one of ordinary skill in the art. Preferred methods, techniques, devices, and materials are described, although any methods, techniques, devices, or materials similar or equivalent to those described herein may be used in the practice or testing of the present invention. Structures described also refer to their functional equivalents.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

From reading the present disclosure, other variations and modifications will be apparent to persons skilled in the art. The variations and modifications may have equivalent and other features already known in the art, and which may be used instead of or in addition to the features described in the present invention.

Features described for separate embodiments may also be provided in combination in one embodiment. Conversely, various features described in the context of a single embodiment for brevity, may also be provided separately or in any suitable combination.

Although Claims have been formulated in this Application to certain combinations of features, the scope of the present disclosure also includes any novel feature or combination disclosed either explicitly or implicitly or in generalization thereof, whether or not it relates to the same invention as presently claimed in any Claim and whether or not it mitigates any or all of the same technical problems as the present invention.

It is to be understood that any exact measurements/dimensions or materials described herein are examples of suitable configurations and are not intended to be limiting in any way. Depending on the needs of the application, those skilled in the art will recognize, in light of the following teachings, various suitable alternatives.

In resistance welding, conventional wisdom may infer the electrode and the holder require a physically tight fit to make a suitable electrical connection for the welding current. The prior electrodes and holders are certainly tight being bound by self-holding tapers or threaded couplings. Tight in this context means the electrode is not easily separated from the holder. Tools may be needed to remove the electrode. The tight fit also prevents arcs and sparks in the holder, prevents leakage of liquid coolant, and prevents electrodes falling off unintentionally.

Recent advancements in materials and machining capabilities have been overlooked or underappreciated as a means for producing better electrodes and holders. A new theory of operation discovered and tested by the Applicants confirms that welding current does not require a tight fit, or even a strong physical binding of the electrode to the holder. This is unprecedented for the electrode to obtain any benefit of tightness without being tight.

The new theory included discoveries of a primary electrical connection and a secondary electrical connection. Regarding the primary electrical connection, the Applicant's new theory holds that a weak interference fit between the electrode and the holder may be sufficient for carrying the welding current. Regarding the secondary electrical connection, the theory also holds that a self-releasing fit between the electrode and the holder may supplement or replace the primary electrical connection.

A first prototype incorporating the new theory was tested. The welding current was increased through consecutive welding trials until it was greater than the workpiece could handle. A surprising, unexpected result occurred when making test weld nuggets. The workpiece produced sparks while the primary electrical connection and the secondary electrical connection did not.

The first prototypes had a slow leakage of coolant fluid. The leak was eliminated in later prototypes by including an elastomeric element comprising a rubber O-ring. Overheating of the rubber was identified for consideration. Subsequent testing revealed the O-ring was not substantially overheated.

More extensive testing provided another unexpected result regarding the electrode's useful service life. It lasted, at least as long, if not longer than, the conventional electrodes. A workpiece contact area of the prototype electrode deteriorated slower than expected. This satisfactory result, as well as the absence of O-ring overheating, may be attributed, at least in part, to faster heat transfer from the electrode to the holder through the primary electrical connection and the secondary electrical connection.

The Applicants encountered difficulties devising and fabricating prototypes due to conflicting requirements for the electrode and the holder. In conventional welding machines, the workpiece is clamped between two electrodes, then the welding current is enabled. A strong binding exists between the electrode and the holder. This may be a tight interference fit which conveys the clamping force to the workpiece. When self-locking tapers are utilized, the tight fit may become tighter by repeated impacts of the workpiece clamping force. The tight fit also enables the extracting force to withdraw the electrode from the workpiece. But the Applicants desired to test prototypes in which the electrode may be easily separated from the holder.

Through extensive planning and fabricating efforts, the Applicants also tested and confirmed a second new theory of better latches for binding the electrode to the holder. This new theory holds that a looseness or slack may be acceptable when the latch sufficiently binds the electrode to the holder and enables the extracting force to pull the electrode off the workpiece in a normal mode of operation. In this respect, the normal mode of operation for the instant invention may be evocative of the abnormal mode of operation for prior-art devices.

But the electrode may not dislodged unintentionally from the holder due to the latch having looseness or slack in accordance with the instant invention. One indication of the latch having the looseness or slack may be the creation of a reversing gap between surfaces of the electrode and the holder when the extracting force pulls the electrode off the workpiece. Another indication of looseness or slack may be in an assembly of the electrode and the holder in which the electrode is bound to the holder but the electrode may be moved, rotated, and/or partially rotated relative to the holder whether or not the assembly is installed in the welding machine.

Looseness or slack is unprecedented in this context. It bestows new freedom in designing and manufacturing the latch. It also enables new designs enabling faster and easier release of the electrode from the holder upgrading the latch type to a quick-release mechanism in some embodiments of the invention.

In accordance with the present invention, the welding electrode and the holder include the primary electrical connection for carrying welding current between the electrode and the holder. The primary electrical connection may have a flexible member with one or more flex-enabling elements. In some embodiments this includes a wall of the holder having one or more gaps which may viewed as separating the wall into one or more wall segments. The primary electrical connection may also include a pressure element which is pressed against the flexible member when the electrode and the holder are joined. The pressure element may include a tapered portion of the electrode.

The pressure element may flex the flexible member creating a flexure force of the weak interference fit. It pushes the electrode and the holder together to “make” the primary electrical connection. The electrode and the holder may be easily separated to “break” the primary electrical connection.

The weak interference fit may provide the flexure force between the pressure element and the flexible member. The flexibility of the flexible member enables the electrode and the holder to be easily separated, the weak interference fit notwithstanding. Separation requires substantially less effort than the prior art devices. Bare hands may provide sufficient force for separating the electrode and the holder in accordance with the specifications described herein. If a gripping tool is used, the applied torque may be less than 12 foot-pounds, and preferably less than 2 foot-pounds.

The quick-release mechanism may be included to prevent unintentional separation of the electrode and the holder. An embodiment of the quick-release mechanism may include a spring latch with a sleeve, a spring, and one or more balls with a corresponding notch. The balls may be retained in the notch by the sleeve. The spring provides a spring force which holds the sleeve in place, keeping the balls in the notch, and preventing dislodgement of the electrode from the holder.

The spring latch may be activated with one hand sliding the sleeve and displacing the spring, compressing it. In response to the spring's displacement, the sleeve moves away from the notch allowing the balls to exit the notch, enabling the electrode to be removed from the holder. Using the other hand, the electrode may be rotated and/or pulled from the holder.

In another embodiment of the invention, the quick-release mechanism includes the spring latch comprising a spring-loaded plunger and a receiving hole. The plunger may include a plunger body, a spring, and a plunger nose. The spring is inside the body between it and the plunger nose. The spring is pre-loaded ensuring the nose protrudes from the plunger body in the spring's nondisplaced state. To install the electrode on the holder, one hand may activate the spring latch by depressing the nose to displace the spring by compression. The nose goes into the plunger body in response to the spring's displacement. Then the other hand may push the electrode onto the holder. Finally, the nose is released allowing it to protrude from of the body, through the receiving hole, and lock the electrode on the holder.

The nose protruding through the receiving hole may prevent unintentional dislodgement of the welding electrode from the holder. It may also prevent electrode rotation and enable machining or dressing of the electrode while it is on the holder. In this respect, without limitation, the nose and the receiving hole may members of one embodiment of a rotation-resistant device.

To remove the electrode from the holder, one hand may activate the spring latch by pressing on the plunger nose. The spring is displaced by compression and the nose responds by going into the plunger body. The other hand may then pull the electrode off the holder.

Page 2 of a Tip Dressing Tools catalog shows a tip dresser having a pneumatic motor and a rotary cutting tool. In use, the motor rotates the blade which is held in contact with the electrode. Since the electrode will not rotate, the blade may cut the tip and removes some metal to modify or recondition the tip surface of the electrode. The publish date of this catalog is not shown but it may be prior to 2017.

A new term and concept is the primary electrical connection. It has the following unique properties; a) provides the benefits of tightness without being tight, b) does not self-lock through repeated resistance spot welding, c) tools may not be required to remove the electrode from the holder, d) bare hands may be sufficient to make or break this connection, e) may insufficiently bind the electrode to the holder for withdrawing the electrode from the workpiece, f) may provide lower electrical resistance, less power loss, and faster heat flow away from the electrode, and g) may enable self-alignment of the electrode with the holder eliminating manual alignment when changing the electrode.

Another new term and concept is the secondary electrical connection. It has the following unique properties; a) may rely on only the workpiece clamping force to make this connection, b) reversal of the workpiece clamping force (the extracting force) may break this connection, c) may handle the welding current if the primary electrical connection fails or is deleted, d) is self-releasing, e) enables easy removal of the electrode from the holder, d) bare hands may be sufficient to make or break this connection, e) may insufficiently bind the electrode to the holder for withdrawing the electrode from the workpiece, f) may include support surfaces for the workpiece clamping force preventing deformation of the holder and the electrode to preserve their alignment, and g) may increase that electrode's surface area in contact with the holder to provide lower electrical resistance, less power loss, and faster heat flow away from the electrode.

Another new term and concept is the quick-release mechanism. It has the following unique properties; a) binds the electrode and holder enabling the extracting force to withdraw the electrode from the workpiece, b) optimized for substantially easier removal of the electrode from the holder, c) bare hands may be sufficient to activate, i.e. unlatch the electrode from the holder, d) current-handling capability may be irrelevant, and e) may be diminutive enabling welding of a variety of workpieces or workpieces with smaller contours.

Another new term and concept is the flexible member. It is a component of the primary electrical connection. It may be a component of the holder or the electrode. The flexible member may include a tension groove which facilitates flexure. The primary electrical connection may have at least one flexible member and at least one pressure element which may be joined by the weak interference fit.

Another new term and concept is the pressure element. It is another component of the primary electrical connection. When the electrode and the holder are joined, the flexible member may be flexed by the pressure element or by another flexible member. The pressure element may include, without limitation, a taper, a primary taper, and/or a tapered hole. The pressure element may be a component of the electrode. The pressure element may be a component of the holder.

The flexible member allows the benefits of tightness without being tight. It enables easier separation of the electrode from the holder. Many prior devices have interlocking tapers or screw threads for binding the electrode to the holder. None of these are as flexible. They may self-lock through repeated resistance spot welding. Prior patents such as Yang teach toward greater self-locking and tightness, away from the interference fit.

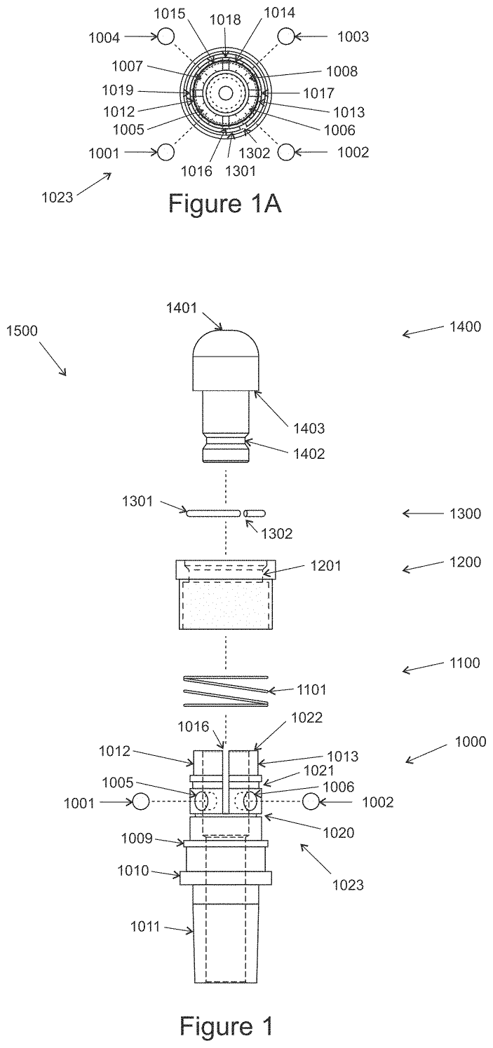

FIG. 1 shows an aspect of the invention in which a Quick-Release Mechanism 1500 may prevent accidental dislocation of an Electrode 1400 from a Holder 1000. The Quick-Release Mechanism 1500 has the spring latch which includes Balls 1001,1002,1003,1004, Ball Holes 1005,1006,1007,1008, a Spring 1100, a Ball Retainer Sleeve 1200, a C-Clip 1300, and a Retaining Groove 1402 on the Electrode 1400. The Quick-Release Mechanism 1500 may facilitate removal of the Electrode 1400 from the Holder 1000 with tools or with bare hands.

When the Holder 1000 is assembled, the Balls 1001,1002,1003,1004 are in the Ball Holes 1005,1006,1007,1008. The Spring 1100 and the Ball Retainer Sleeve 1200 are over the Holder 1000. The Spring 1100 is between a Spring Stop 1009 and an Interior Surface 1201 of the Ball Retainer Sleeve 1200. The C-Clip 1300 is in a C-Clip Groove 1021. They retain the Ball Retainer Sleeve 1200 and the Spring 1100. The Spring 1100 may include a Coil or Wire 1101 for providing a spring force. The C-Clip 1300 may include a curled Wire Segment 1301 with a Gap 1302 providing the opening of the “C”.

The Holder 1000 has a flexible member with a plurality of Holder Wall Segments 1012,1013,1014,1015 as shown in FIG. 1A. The flexible member has a Flex-Enabling Element 1023 which includes a plurality of Gaps 1016,1017,1018,1019 located between the wall segments. The Flex-Enabling Element 1023 also includes a Tension Groove 1020 as shown in FIG. 1. The gaps and the tension groove increase flexibility of the flexible member.

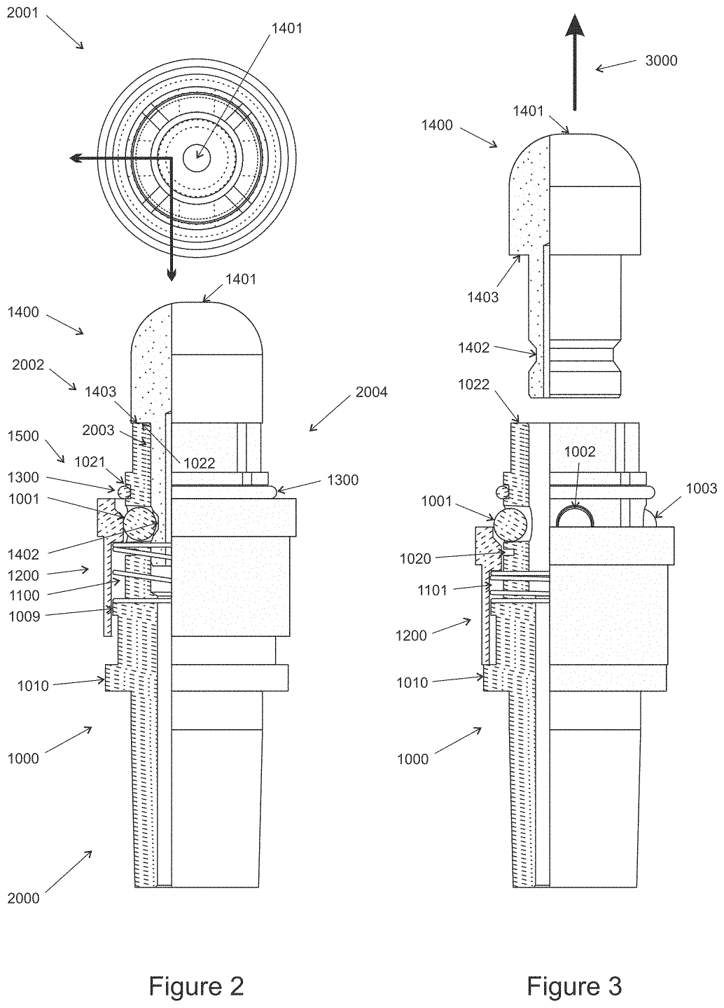

FIG. 2 shows a Side View 2000 of an Electrode 1400 and the Holder 1000 in an Assembly 2004. A Top View 2001 includes two perpendicular arrows defining cut-away sections of the Side View 2000. The Assembly 2004 creates a Primary Electrical Connection 2003 between the Electrode 1400 and the Holder 1000.

The Electrode 1400 is bound to the Holder 1000 by the Balls 1001,1002,1003,1004 and the Sleeve 1200. The Spring 1100 is between the Ball Retainer Sleeve 1200 and the Spring Stop 1009. The Spring 1100 pushes the Sleeve 1200 upward against the C-Clip 1300. The Interior Surface 1201 of the Sleeve 1200 pushes the balls inward toward the electrode shank until they are seated in the Retaining Groove 1402.

The sleeve, the balls, and the retaining groove prevent the electrode from falling out of the holder. The balls may not fit snugly in the groove. They may be smaller than the groove and/or rattle in the groove, causing the looseness or slack of the latch. To prevent rotation of the electrode on the holder the groove may be replaced by other retaining mechanisms such as, without limitation, teardrop, whistle-notch, or combinations thereof.

The workpiece clamping force may be applied to the workpiece through the Assembly 2004, closing any gap that exists between a Holder Support Surface 1022 and an Electrode Support Surface 1403. The workpiece clamping force overrides the looseness or slack in the quick-release mechanism and brings the surfaces together into physical contact as shown. The surfaces may form a Secondary Electrical Connection 2002 which supplements the Primary Electrical Connection 2003 by increasing the overall surface area for the welding current to pass through.

FIG. 3 shows the Electrode 1400 removed from the Holder 1000. This may be accomplished with tools or with bare hands by activating the spring latch of the Quick-Release Mechanism 1500 and pulling the Electrode 1400 upward in the direction of an Arrow 3000. The spring latch may be activated by pushing the Sleeve 1200 downward until it rests against a Sleeve Stop 1010. This action compresses the Spring 1100. The Balls 1001,1002,1003,1004 roll outward away from the Retaining Groove 1402 enabling the electrode to be separated from the holder.

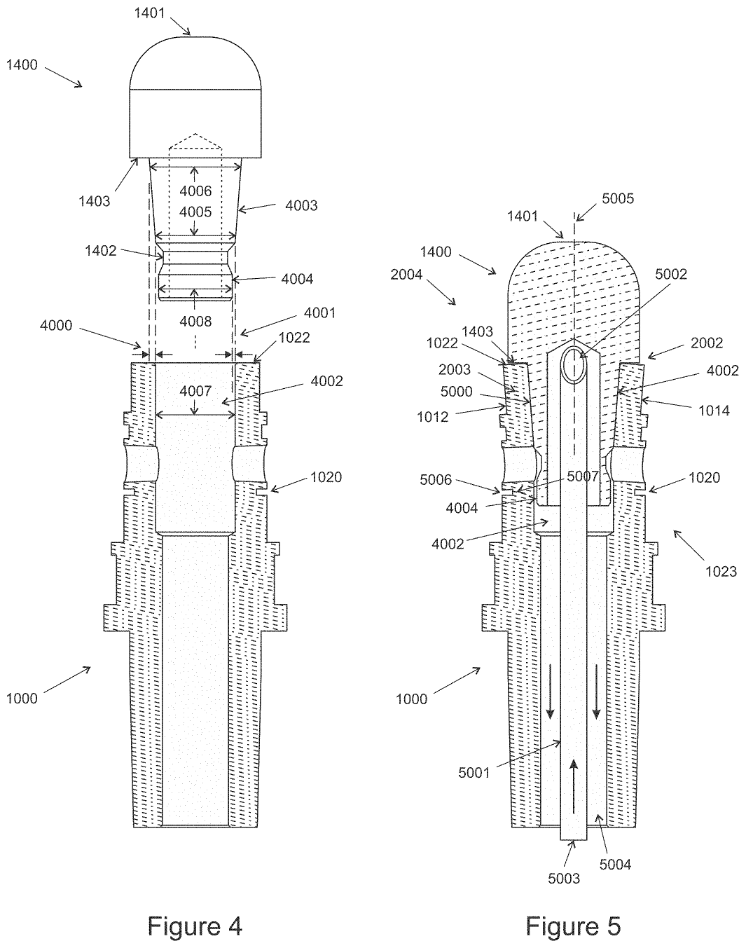

FIG. 4 shows the Holder 1000 with a section removed to reveal a Primary Bore 4002 and illustrate a key aspect of the invention in which a Primary Taper 4003 and a Bore Diameter 4007 form a Weak Interference Fit 4000 of the Primary Electrical Connection 2003. The Primary Taper 4003 is exaggerated in FIGS. 4 and 5 for illustration.

FIG. 5 shows the Holder 1000 and the Electrode 1400 in the Assembly 2400. The Primary Taper 4003 and the Primary Bore 4002 form an Electrical Contact Surface 5000 and make the Primary Electrical Connection 2003. The Primary Taper 4003 expands the plurality of Holder Wall Segments 1012,1014 (and Holder Wall Segments 1013,1015 which are not shown). The wall expansions create flexure forces and pushes surfaces of the walls and the Primary Bore 4002 together bringing them together to provide a suitable path for the welding current to flow between the Holder 1000 and the Electrode 1400. The flexible member is embodied by the Holder Wall Segments 1012,1014,1013,1015. The pressure element is embodied by the Primary Taper 4003. The Holder Wall Segments 1012-1015 are expanded by the Primary Taper 4003, away from a Centerline 5005.

A Smaller Diameter 4005 of the Primary Taper 4003 may be practically the same dimension as, or smaller than, the Primary Bore 4002 with a tolerance of +/−0.0005″. The Primary Taper 4003 may have a Larger Diameter 4006 that is 0.0002″ to 0.010″ greater than the Bore Diameter 4007. The Bore Diameter 4007 may be a constant dimension (meaning it has no taper) or it may also be tapered.

The Weak Interference Fit 4000 may be able to maintain precision because it is not substantially tightened by the pressure of repeated impacts (from the workpiece clamping force) during the resistance spot welding process. The Support Surfaces 1403,1022 may bear most of the impact force. Less deformation of the parts may occur enabling better self-alignment of the electrode and the holder. The parts may be machined for alignment and that alignment may be preserved by less deformation of the electrode and the holder.

The expansion shown in FIG. 5 is substantially greater than expansions that may occur in prior-art electrodes due to the flexibility of the flexible member. The flexibility parameters may be planned by configuring the Flex-Enabling Element 1023 to includes the gaps between the wall segments as shown in FIGS. 1 and 1A, and the Tension Groove 1020, which has a width that is narrowed by the expansion. As shown, in FIG. 5, an Outer Width 5006 of the Tension Groove 1020 narrows relative to an Inner Width 5007 of the groove.

FIGS. 4 and 5 show another aspect of the invention in which a Plug 4004 and a Clearance Fit 4001 prevent the coolant from substantially leaking out of the region between the Holder 1000 and the Electrode 1400. The Clearance Fit 4001 is formed by a Plug Diameter 4008 being smaller than the Bore Diameter 4007. When the Electrode 1400 is inserted into the Holder 1000, the Plug 4004 blocks the top of the Primary Bore 4002. The Plug Diameter 4008 may be slightly smaller than the Primary Bore 4002 within a tolerance of +0.0000″ to −0.0007″. In FIGS. 4 and 5, the Clearance Fit 4001 is exaggerated for illustration.

In operation, the welding machine, to which the holder and electrode are affixed, has a pump that circulates coolant fluid through a Coolant Pipe 5001. The coolant enters at a Coolant Inlet 5003. The fluid exits the Coolant Pipe 5001 at an Orifice 5002. It cools the Electrode 1400 then flows downward into the Primary Bore 4002 where it cools the Holder 1000. The coolant exits through a Coolant Outlet 5004 at the bottom of the Holder 1000.

The Electrical Contact Surface 5000 of the Primary Electrical Connection 2003 may be beneficial in cooling the Electrode 1400. The Electrode 1000 has a Workpiece Contact Area 1401 where heat is generated while welding. If it gets too hot, the electrode's metal may melt or corrode, shortening the electrode's useful service life. Dissipating the heat faster enables longer electrode service life or more workpieces may be welded per hour. Locating the Orifice 5002 in the Electrode 1400 as shown is helpful. The Electrical Contact Surface 500 may be substantially greater than a typical electrical connection of the prior art. The larger surface area has less resistance to heat flowing away from the Electrode 1400 into the Holder 1000. It enables heat to leave the electrode faster.

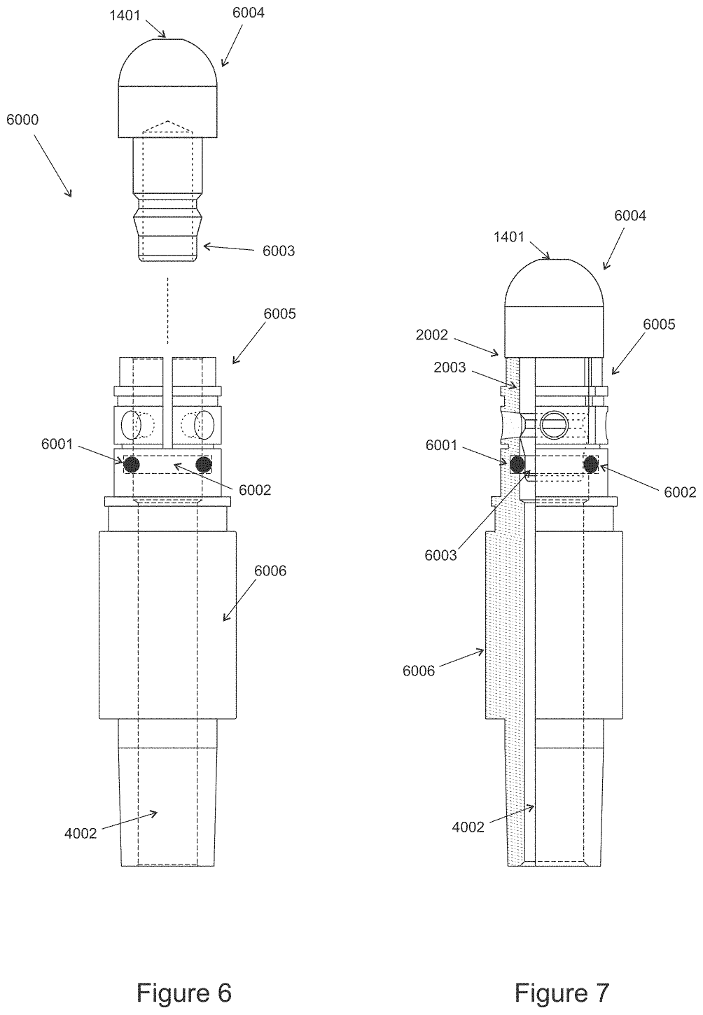

FIG. 6 shows another embodiment of the invention in which coolant fluid leakage may be prevented during operation. It includes a Holder 6005 having a Coolant Seal 6000 with a Rubber O-Ring 6001, an O-Ring Groove 6002, and an Electrode 6004 with a Piston 6003. The Quick-Release Mechanism 1500 is included but not shown. The O-Ring 6001 is in the O-Ring Groove 6002 and may be laterally uncompressed when the Electrode 6004 is not in the Holder 6004. In operation, the Electrode 6004 is in the Holder 6004 laterally compressing the O-Ring 6001 between the Piston 6003 and the O-Ring Groove 6002 as shown in FIG. 7. This completes the Coolant Seal 6000 and may prevent coolant leakage. This embodiment also includes a Heatsink 6006 which may facilitate cooling of the Holder 6005 and the Electrode 6004. The Heatsink 6006 is an enlarged region of the Holder 6005, which may also serve as a region for a gripping tool such as a pipe wrench, pliers or locking pliers.

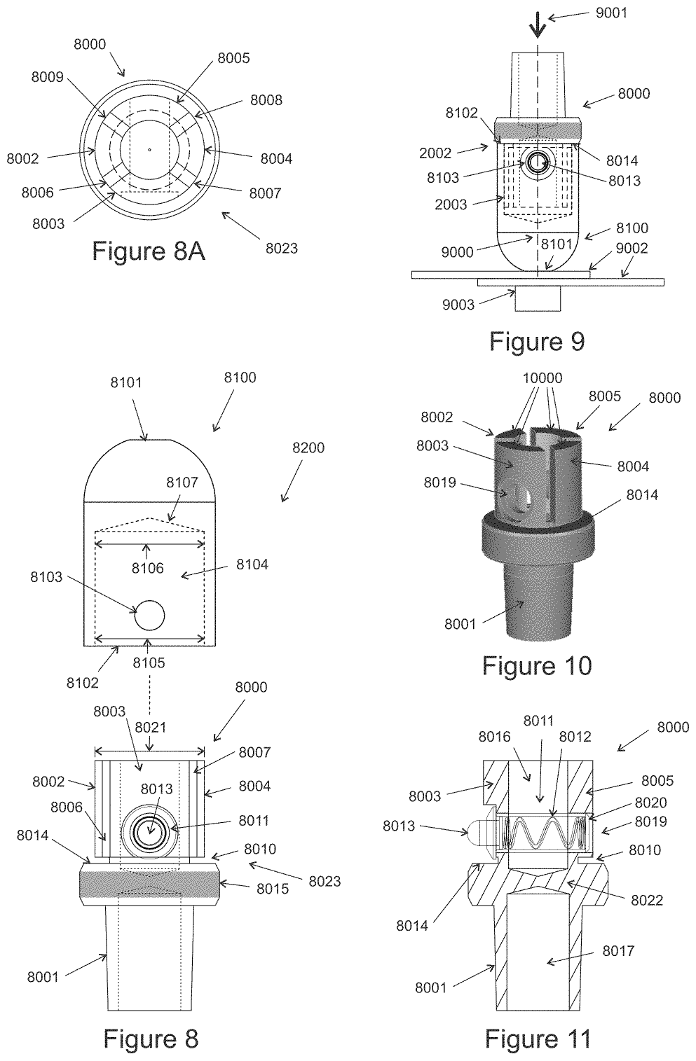

FIG. 8 shows an embodiment of the invention having a Short Holder 8000 and a Rotation-Resistant Electrode 8100. The Holder 8000 has the flexible member which includes Holder Wall Segments 8002,8003,8004,8005, a Flex-Enabling Element 8023 comprising gaps 8006,8007,8008,8009, and a Tension Groove 8010. The Holder 8000 also has a Holder Support Surface 8014, a Knurl 8015, a Dry Bore 8016, and a Coolant Bore 8017. The Electrode 8100 has a Workpiece Contact Area 8101, an Electrode Support Surface 8102, a Receiving Hole 8103, and the pressure element comprising a Tapered Hole 8104 having a Top of Tapered Hole 8107.

A Quick-Release Mechanism 8200 includes the spring latch comprising a Spring-Loaded Plunger 8011 and the Receiving Hole 8103. The plunger has a Plunger Spring 8012 located between a Plunger Body 8020 and a Plunger Nose 8013. The Plunger Spring 8012 is pre-loaded to ensure the Plunger Nose 8013 protrudes from the Plunger Body 8020.

FIG. 11 shows the Holder 8000 rotated 90 degrees and the Spring-Loaded Plunger 8011 is installed in a Plunger Hole 8019. An interference fit may exist between the inner diameter of the Plunger Hole 8019 and the outer diameter of the Plunger Body 8020 to hold the Plunger 8011 in place.

FIG. 10 shows the Holder 8000 and the Holder Support Surface 8014. The Plunger and the Electrode 8100 are omitted from this view. In an assembly of the electrode and the holder, the Support Surfaces 8014,8102 may touch each other. The Support Surface 8014 may be a portion of the holder shaped as a first ring which faces a second ring being a portion of the electrode which may be referred to as the Support Surface 8102.

FIG. 9 shows the Electrode 8100 in the assembly with the Holder 8000. The flexure of the flexible member in this embodiment is a compression, as opposed to the expansion shown in the embodiment of FIG. 5. The Tapered Hole 8104 compresses the Wall Segments 8002,8003,8004,8005 toward a Centerline 9000 of the Holder 8000.

A Larger Diameter 8105 of the Tapered Hole 8104 may be practically the same dimension as a Wall Diameter 8021 with a tolerance of +/−0.0005″. A Smaller Diameter 8106 may be 0.0002″ to 0.010″ less than the Wall Diameter 8021. The Wall Diameter 8021 may be a fixed dimension (meaning it has no taper) or it may be tapered.

In the assembly, the Plunger Nose 8013 goes through the Receiving Hole 8103 retaining the Electrode 8100 on the holder and preventing rotation of the electrode. To release the electrode from the holder, one may use a hand to depress the Plunger Nose 8013, compressing the Plunger Spring 8012, and pushing the nose into the Plunger Body 8020. The other hand may then pull the electrode off the Holder 8000.

In operation, the welding machine applies a Workpiece Clamping Force 9001 to the Holder 8000, which then passes the force on to the electrode and a Workpiece 9002. The workpiece is supported by a Stationary Electrode 9003 which opposed the clamping force. The Workpiece clamping force 9001 enables the Secondary Electrical Connection 2002 by bringing the rings of the Support Surfaces 8014,8102 together. This may increase the overall area of physical contact between the electrode and holder decreasing resistance to their transfer of heat and/or electricity to each other.

The Support Surfaces 8014,8102 may rely on the Workpiece Clamping Force 9001 to establish physical contact with each other and enable formation of the weld nugget. But afterwards, the welding machine reverses the Workpiece Clamping Force 9001, enables the extracting force, and withdraws the electrode from the workpiece. When reversed, the Workpiece Clamping Force 9001 may be referred to as the extracting force. The extracting force may be represented graphically as an arrow pointing in the opposite direction as Workpiece Clamping Force 9001. The extracting force may separate the Holder Support Surface 8014 from the Electrode Support Surface 8102 and disable the Secondary Electrical Connection 2002. The ring surfaces may be self-releasing in furtherance of the electrode's easy removal from the holder.

FIG. 10 also show a Top of Walls 10000 which is flat and faces the Top of Tapered Hole 8107 inside the electrode. In a variation of the holder and the electrode, the Holder Support Surface 8014 may include the Top of Walls 10000, and the Electrode Support Surface 8102 may include the Top of Tapered Hole 8107. The Top of Walls 10000 and the Top of Tapered Hole 8107 may be configured to match and make physical contact when the Workpiece Clamping Force 9001 is applied. This variation may further increase the effectiveness of the Secondary Electrical Connection 2002.

No quick-release mechanism or latch has to enable or maintain any electrical connection which is unused while the electrode is withdrawing. The looseness or slack may be harmless if the electrode does not stick to the workpiece and is not dislodged from the holder unintentionally.

The Coolant Bore 8017 has a drilled hole that may contain the liquid coolant. The Dry Bore 8016 is isolated from the Coolant Bore 8017 by a Separation Web 8022 between the two holes. This configuration enables cooling of the Electrode 8100 without coolant leakage.

A First Joining Element 1011 is shown in FIG. 1 and a Second Joining Element 8001 is shown in FIG. 8. These may be utilized to affix the holder to the welding machine. They may be configured for fitting preexisting receptacles of the welding machine. Without limitation, they may include, a taper, a thread, a notch, a set screw, a self-holding taper such as a Morse Taper or a Jacobs Taper.

The First Joining Element 1011 may include a standard electrode taper. Each embodiment of the invention may have an appropriate joining element, standard or otherwise, as required for compatibility with the welding machine. Without limitation, the joining elements may include standard electrode tapers designated as 4RW, 5RW, 6RW, or 7RW, or standard cap tapers designated as 4CT, 5CY, 6CT, or 7CT.

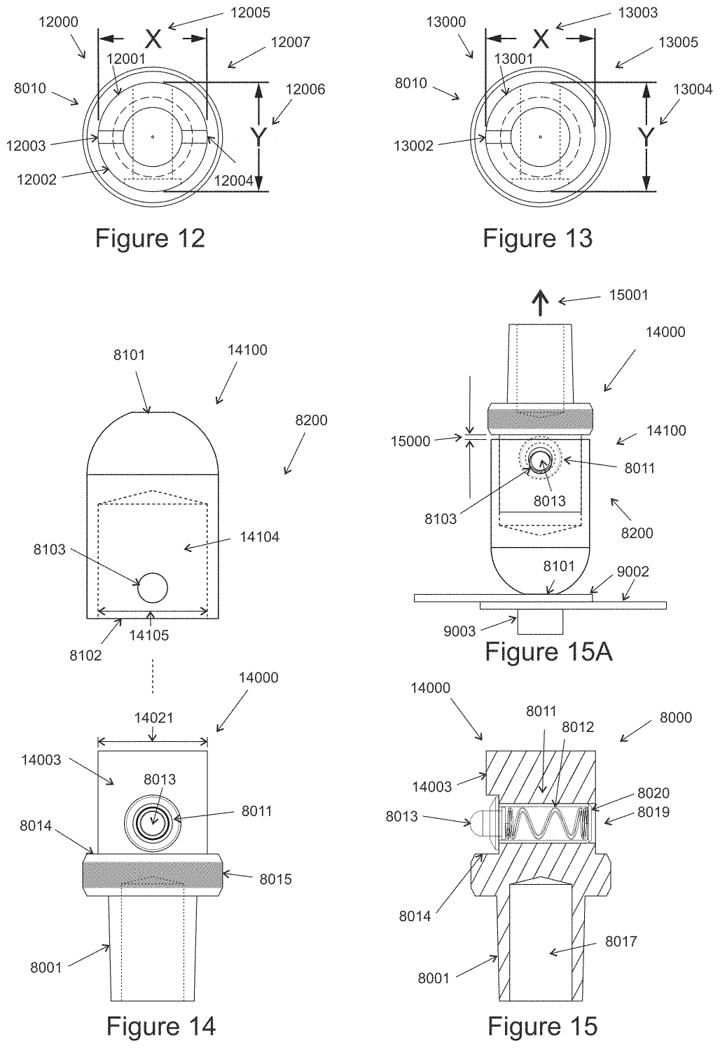

FIG. 12 shows another embodiment of the invention having a 2-Gap Holder 12000 with a Flex-Enabling Element 12007 having only two Gaps 12003, 12004, two Holder Wall Segments 12001, 12002, and the Tension Groove 8010. Without limitation, the 2-dimensional shape defined by a top view of the holder wall may be round, obround, oval, circular, or elliptical. A First Dimension 12005 may be shorter than a Second Dimension 12006 in compensation of greater stiffness of the walls flexing in the X dimension, relative to the Y dimension, due to the orientation of the Gaps 12003, 12004.

FIG. 13 shows another embodiment of the invention having a 1-Gap Holder 13000 with a Flex-Enabling Element 13005 having only one Gap 13002, one Holder Wall Segments 13001, and the Tension Groove 8010. Without limitation, the 2-dimensional shape defined by a top view of the holder wall may be round, obround, oval, circular, or elliptical. A First Dimension 13003 may be shorter than a Second Dimension 13004 in compensation of greater stiffness of the wall flexing in the X dimension, relative to the Y dimension, due to the orientation of the Gap 13002.

FIG. 14 shows an embodiment of the invention having a Worn Holder 14000 and a Rotation-Resistant Electrode 14100. This may be a fault mode of a previous embodiment described herein. The flexible members and the pressure element may be damaged. They may be rendered ineffective through usage and wear. Or there may be a defect in manufacturing of component parts. Regardless of the cause, the primary electrical connection is deleted. The follow paragraphs describe the superior fault-tolerance of the present invention regarding the secondary electrical connection.

The Tapered Hole 8104 of FIG. 8 is replaced by a Clearance Hole 14104. The wall segments of FIG. 8 are replaced by an Alignment Boss 14003. The Smaller Diameter 8106 and the Larger Diameter 8105 are replaced by a Clearance Diameter 14105. The Wall Diameter 8021 is replaced by a Boss Diameter 14021. The Alignment Boss 14003 and the Clearance Hole 14104 have a clearance-fit because the Clearance Diameter 14105 is greater than the Boss Diameter 14021. This may be an unsuitable electrical connection for the welding current.

In assembly, the Electrode Support Surface 8102 may be in physical contact with the Holder Support Surface 8014 creating the Secondary Electrical Connection 2002 like FIGS. 8 and 9. The Secondary Electrical Connection 2002 may handle the welding current when the Workpiece clamping force 9001 is sufficient to ensure a suitable path for electricity to flow through the Support Surfaces 8014,8102.

FIG. 15 shows a side view of the Holder 14000. It includes the Spring-Loaded Plunger 8011 in the Plunger Hole 8019. The Holder Wall Segment 8002-8005, the Gaps 8006-8009, the Tension Groove 8010, the Separation Web 8022, and the Dry Bore 8016 may be deleted.

FIG. 15A shows the Rotation-Resistant Electrode 14100 assembled with the Worn Holder 14000. There is a Reversing Gap 15000 between them. The gap may be the consequence of the looseness or slack in the latch comprising the Quick-Release Mechanism 8200. The Plunger Nose 8013 is shown off-center relative to the Spring-Loaded Plunger 8011 and/or the Receiving Hole 8103. When the workpiece clamping force was earlier applied in the process of forming the weld nugget, the Reversing Gap 15000 may have been closed and the secondary electrical connection enabled by the workpiece clamping force.

The workpiece clamping force is shown reversed and the electrode may stick to the workpiece. An Extracting Force 15001 tries to pull the electrode away from the Workpiece 9002, but the electrode may be sticking to the workpiece. The looseness or slack of the latch may allow the holder to move away from the workpiece while the electrode remains attached to the workpiece. It may be attributed, at least in part, to the diameter of the Receiving the Hole 8103 being greater than the diameter of the Plunger Nose 8013. The Plunger Nose 8013 may move off-center until it strikes an inside edge of the Receiving Hole 8103. Then the looseness or slack may not allow any further movement of the nose. With the looseness or slack consumed (as shown), the Reversing Gap 15000 is opened and the Quick-Release Mechanism 8200 may begin to transfer the extracting force to the electrode, eventually pulling it away from the workpiece.

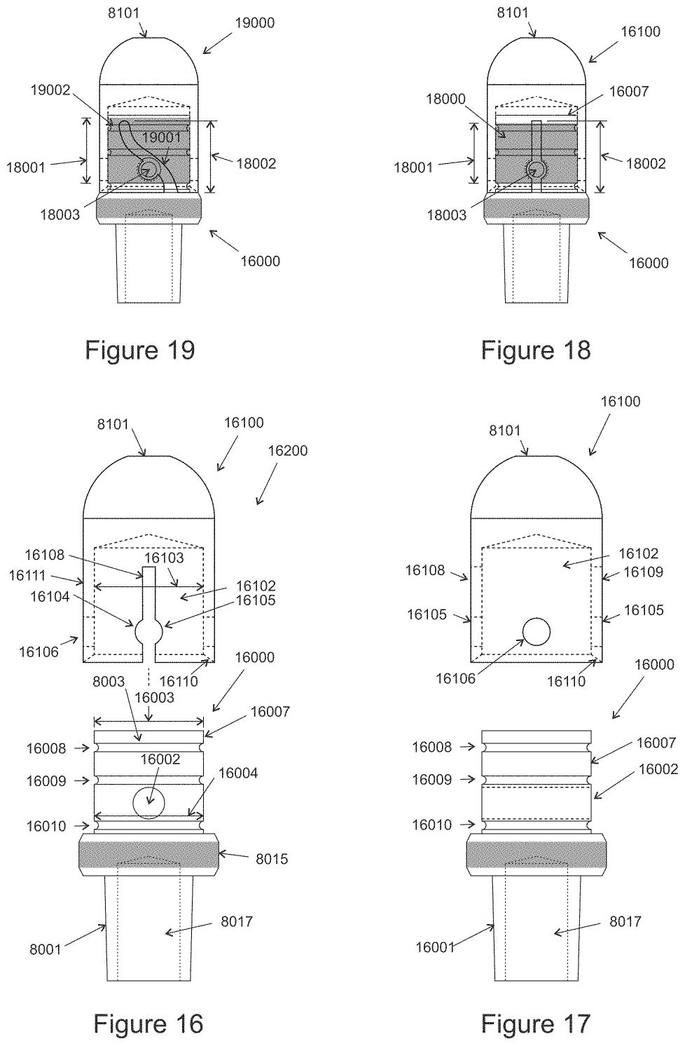

FIG. 16 shows another embodiment of the invention having the primary electrical connection without the secondary electrical connection. A Pin-Lock Holder 16000 and a Rotation-Resistant Electrode 16100 may be fastened together by a Mechanical Latch 16200. The Holder 16000 includes the Joining Element 8001, the Coolant Bore 8017, and the Knurl 8015. The pressure element comprises a Fitting Boss 16007, Relief Grooves 16008-16010, a Pin Hole 16002, a Slip-Fit Dimension 16003, and an Interference-Fit Dimension 16004.

The Electrode 16100 includes the Workpiece Contact Area 8101, an Alternate Hole 16106, and an Inner Bevel 16110 which prevents the secondary electrical connection from forming. The flexible member comprises an Outer Wall 16111 with a Boss Hole 16102 having a Hole Dimension 16103, a Gap 16108 with a Bulge 16104 and a Bulge 16105, and a similar Gap 16109 (shown in FIG. 17). The gaps separate the Outer Wall 16111 into multiple wall segment. FIG. 17 shows the Holder 16000 and the Electrode 16100 rotated 90 degrees.

FIG. 18 shows the Holder 16000 and the Electrode 16100 assembled. The Mechanical Latch 16200 includes the Bulges 16104,16105, the Alternate Hole 16106, the Boss Hole 16102, and a Locking Device 18003 which may be inside the Boss Hole 16102 and between the Bulges 16104,16105 during operation. Alternatively, the Electrode 16100 may be turned 90 degrees allowing the Locking Device 18003 to go through the Alternate Hole 16106 instead of the Bulges 16104,16105. Without limitation, the Locking Device 18003 may include a hitch pin, a ball lock pin, a clevis pin, a grooved pin, a bolt and nut, a screw, a cotter pin, a lock pin, and/or a scaffolding pin.

FIG. 18 also shows a Weak Interference Fit 18000 region with an Interference Height 18001 in which the Fitting Boss 16007 may transition from the Interference-Fit Dimension 16004 to the Slip-Fit Dimension 16003. The Fitting Boss 16007 may be larger than the Boss Hole 16102 in the Weak Interference Fit 18000. The Gap 16108 may have a Longitudinal Dimension 18002 which is greater than 85% of the Interference Height 18001. Written as a fit equation, LD>0.85×IH, where LD is the Longitudinal Dimension 18002, and IH is the Interference Height 18001.

The Mechanical Latch 16200 may not allow rotation of the Electrode 16100 due to the configuration of the Gap 16108 and the Locking Device 18003. Contrary to the teachings of Yang in the '237 patent, a high strength alloy is not required for the Locking Device 18003 to withstand pressure of repeated impact during welding. This embodiment has no mechanism which self-locks through repeated resistance spot welding. The primary electrical connection comprising the Interference-Fit Dimension 16004 may have substantially weaker flexure forces than Yang teaches. Easier disassembly and better self-alignment may be achieved as a result. Disassembly with bare hands may be possible.

FIG. 19 shows another embodiment of the invention in which a Rotation-Resistant Electrode 19000 in assembled with the Holder 16000. It has an Irregular Gap 19001, a similar Irregular Gap 19002 (not shown), and the Locking Device 18003. This embodiment conforms to the fit equation because the Irregular Gap 19001 has a Longitudinal Dimension 18002 which is greater than 85% of the Interference Height 18001.

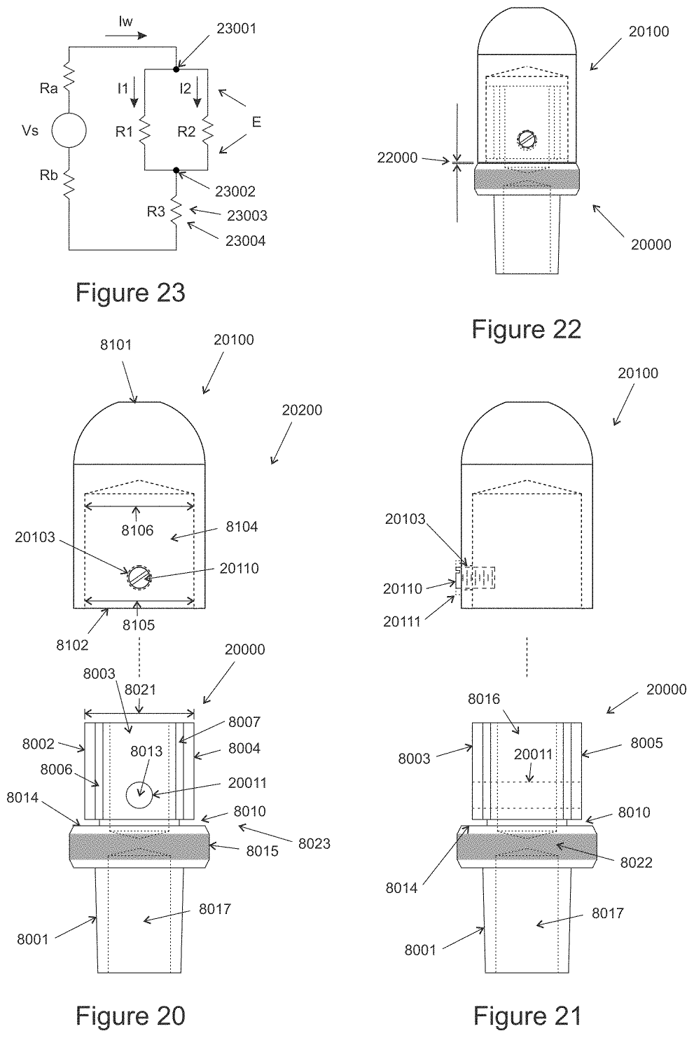

FIG. 20 shows an embodiment of the invention having a Short Holder 20000 and a Rotation-Resistant Electrode 20100. The Holder 20000 includes Holder Wall Segments 8002,8003,8004,8005 with the Flex-Enabling Element 8023 comprising gaps 8006,8007,8008,8009 and the Tension Groove 8010. The Holder 20000 also includes the Holder Support Surface 8014, the Knurl 8015, the Dry Bore 8016, and the Coolant Bore 8017. The Electrode 20100 includes the Workpiece Contact Area 8101, the Electrode Support Surface 8102, and the pressure element comprising the Tapered Hole 8104.

The embodiment has a Mechanical Latch 20200 with a Tapped Hole 20103, a Setscrew 20110 which may have threads matching the Tapped Hole 20103, and a Clearance Hole 20011 in the Short Holder 20000.

In FIG. 21, the Short Holder 20000 and the Rotation-Resistant Electrode 20100 are rotated 90 degrees. The Setscrew 20110 includes an optional Setscrew Head 21111, which may be bigger than the Tapped Hole 20103. This may allow the setscrew to be tightened against the electrode ensuring it remains affixed to the electrode. The Setscrew 20110 outer diameter may be smaller than the Clearance Hole 20011 inner diameter creating the looseness or slack for the latch.

FIG. 22 shows an assembly of the Short Holder 20000 and the Rotation-Resistant Electrode 20100 under the influence of the extracting force. Like other embodiments, this embodiment may have a Reversing Gap 22000 while the extracting force is applied to the assembly, and no reversing gap while the clamping force is applied.

FIG. 23 shows an electrical model of the invention. The welding current may be carried over the primary electrical connection or the secondary electrical connection or both. The model may include the primary electrical connection shown as a First Resistance R1, and the secondary electrical connection shown as a Second Resistance R2. R1 and R2 may be connected in parallel and dividing a Welding Current Iw in inverse proportion to their resistance values, wherein I1/I2=R2/R1, and Iw=I1+I2. Iw may represent the total Welding Current which is provided by a Voltage Source Vs of the welding machine. The Welding Current flows through the primary and secondary electrical connections, through an Electrode 23001 and a Holder 23002, through a Workpiece 23003 and a Weld Nugget 23004 modeled together as a Third Resistance R3. The primary electrical connection carries a Primary Current I1 which may be the portion of Iw which flows through R1. The secondary electrical connection carries a Secondary Current I2 which may be a portion of 1w which flows through R2. The Total Resistance Rt of the primary and secondary electrical connections combined may be Rt=R1×R2/(R1+R2). R1 may be equal to R2, R1 may be less than R2, or R2 may be less than R1. The Welding Current Iw may be Iw=E/Rt, where Connections Voltage E is the voltage across the parallel combination of R1 and R2 (the primary and secondary electrical connections).

The model includes a Top Connections Resistance Ra and a Bottom Connections Resistance Rb. The Top Connections Resistance Ra models the resistance of ancillary electrical connections from an upper terminal of the Voltage Source Vs to and including the Holder 23001. The Bottom Connections Resistance Rb models any ancillary electrical connections from a lower terminal of the Voltage Source Vs to the Third Resistance R3. The Bottom Connections Resistance Rb may include the stationary electrode and its holder. The Third Resistance R3 may be where the main power dissipation occurs, creating substantial heat for creating the Weld Nugget 23004. A thermal model may be similar to the electrical model, where I values may represent heat flows, R1 may represent resistance to the flow of heat through the primary electrical connection, and R2 may represent resistance to the flow of heat through the secondary electrical connection.

The model predicts the secondary electrical connection may decrease the Connections Voltage E per the above equation Rt=R1×R2/(R1+R2). For a non-limiting example, if R1=1 and R2=2, then Rt=1×2/(1+2)=2/3=0.67. For comparison, absence of the secondary electrical connection makes the value of R2 infinite, and Rt is greater, being Rt=1×[infinity]/(1+[infinity])=1. The model predicts lower Power Dissipation Pd in the electrode and holder when the secondary electrical connection is enabled since Pd=Rt×Rt×E. The Lower Rt, the lower Pd. Similarly, the secondary electrical connection provides lower resistance to heat flow from the electrode to the holder. Thus, the secondary electrical connection may improve the electrode's useful service life by decreasing power dissipation and by enabling faster heat-flow out of the electrode.

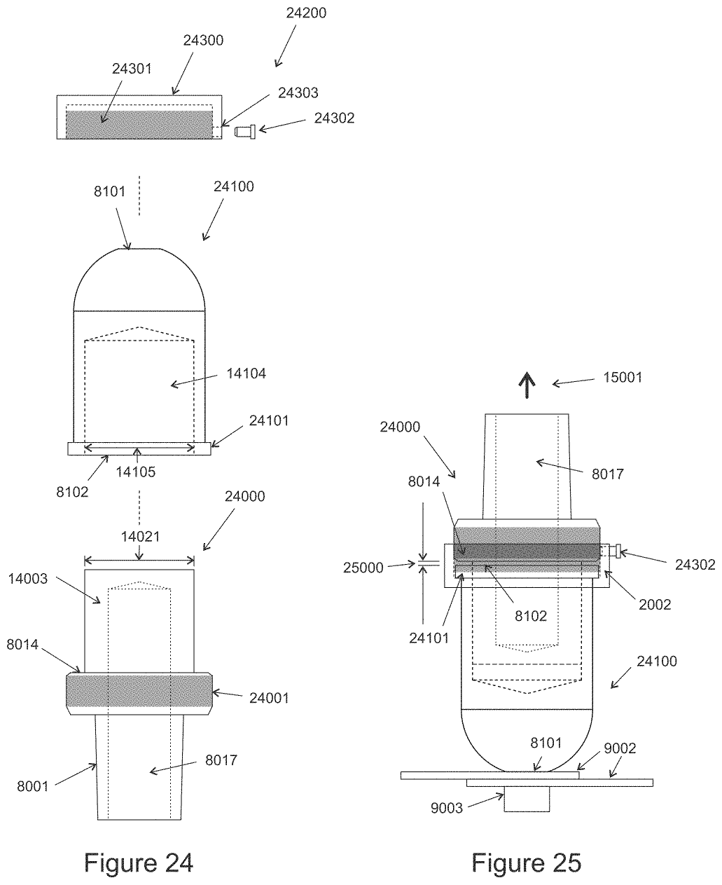

FIG. 24 shows an embodiment of the invention having a Short Holder 24000 and a Floating Electrode 24100 which includes and Electrode Lip 24101, the Clearance Hole 14104, the Clearance Diameter 14105, and the Electrode Support Surface 8102. The Short Holder 24000 includes the Holder Support Surface 8014, External Threads 24001, the Alignment Boss 14003, the Boss Diameter 14021, and the Coolant Bore 8017. The Alignment Boss 14003 and the Clearance Hole 14104 may have a clearance fit. The primary electrical connection is not included. A Mechanical Latch 24200 includes a Threaded Coupling 24300, External Threads 24001, a Setscrew 24302, and a Threaded Hole 24303.

FIG. 25 shows an assembly of the Short Holder 24000, the Floating Electrode 24100, and the Threaded Coupling 24300 which is installed over the Floating Electrode 24100 and affixed to the Short Holder 24000. External Threads 24001 and Internal Threads 24301 are engaged but they are not tightened. The threaded coupling is not loose either. The Setscrew 24302 is in the Threaded Hole 24303 and tightened against the External Threads 24001. This prevents the Threaded Coupling 24300 from dislodging from the assembly.

The Floating Electrode 24100 is free to float up and down. Its downward movement is limited by the Electrode Support Surface 8102 and the Holder Support Surface 8014 making contact. The electrode's upward movement is limited by the Threaded Coupling 24300 and the Electrode Lip 24101 making contact.

In a normal mode of operation of the invention, the workpiece clamping force, or the extraction force, may be applied to the assembly. The workpiece clamping force may push the Electrode Support Surface 8102 into physical contact with the Holder Support Surface 8014 bringing them together to enable the Secondary Electrical Connection 2002. The workpiece clamping force may also prevent movement of the electrode relative to the holder while it is actively being applied to the assembly in the normal mode of operation.

But FIG. 25 is shown with the Extraction Force 15001, which may also occur in the normal mode of operation after the workpiece clamping force is ended (or reversed). A Reversing Gap 25000 is opened between the Electrode Support Surface 8102 and the Holder Support Surface 8014.

Thus, various conditions may exist in the normal mode of operation simultaneously or at different stages. Without limitation, these may include the following conditions: a) the workpiece clamping force closing the reversing gap, b) the workpiece clamping force enabling the secondary electrical connection, c) the workpiece clamping force preventing the electrode moving relative to the holder, d) the extracting force opening the reversing gap, e) the extracting force disabling the secondary electrical connection, f) the electrode moving relative to the holder, or g) combinations thereof.

In other embodiments of the invention, the primary electrical connection may have various combinations of pressure elements and flexible members. In a non-limiting example, an element-A and an element-B may be pressed against each other. The element-A may include a first flexible member. The element-B may include a second flexible member and/or a pressure element. The electrode may have the element-A and the holder may have the element-B, or vice versa. The flexible member may be expanded and/or compressed.

Without limitation, the flexible member may include one or more forks, combs, segments, parts, pieces, separations, filaments, wedges, tubes, cylinders, abutments, supports, braces, or combinations thereof. Likewise, the pressure element may include similar structures.

The flexible member may include one or more springs. Without limitation, the spring may include, compression springs, extension spring, torsion spring, constant force spring, spring washer, drawbar spring, volute spring, flat spring, garter spring, gas spring, air spring, elastomer spring, urethane spring, or combinations thereof.

The flexible member may include one or more hinges. Without limitation, the hinge may include, a strap hinge, a butt hinge, a spring-loaded hinge, concealed hinge, piano hinge, an offset hinge, an overlay hinge, a barrel hinge, a scissor hinge, a gate hinge, or combinations thereof.

In other embodiments of the invention, the flexible member may include one or more flex-enabling elements of various types. Without limitation, the flex-enabling element types may include gap, aperture, hole, void, space, orifice, vent, slot, slit, window, gash, incision, crack, fissure, perforation, cleft, crevice, cut, cavity, cranny, groove, chink, eye, mouth, loophole, peephole, interstice, spyhole, hiatus, interruption, foramen, doorway, gateway, portal, way, entrance, entryway, access, exit, egress, rib, spring, elastomer, depression, removed portion, thinning, reduction in strength, compliance, tensile, elasticity, physical property, or combinations thereof.

In some embodiments disclosed, flexure is produced when the pressure element, which includes taper, is joined with the flexible member, which is without taper. That may be reversed. The pressure element may be without taper and the flexible member may include taper. Or the pressure element and the flexible member may both include taper. While taper may be a preferred flexure provider, other flexure providers are permissible. Without limitation, the flexure provider may include taper, wedge, torque, twist, buckle, motion by bending, or combinations thereof.

In another embodiment of the invention the flexible member may be neither expanded nor compressed. In a non-limiting example, the pressure element may have one or more wedges located between wall segments. The wedges may apply flexure forces to the sides of the wall segments. The flexure forces may include various force vectors. One or more of the force vectors may produce a torque. The torque may be balanced by a counteracting torque.

In FIG. 4, the pressure element comprising the Primary Taper 4003 may have a linear taper. In FIG. 8, The pressure element comprising the Tapered Hole 8104 may have a linear taper as well. Linearity is not required. In other embodiments of the invention, the pressure element and/or the flexible member may include one or more tapes of various types. Without limitation, the taper types may include, linear, convex, concave, steps, bulges, depressions, or combinations thereof.

The Balls 1001,1002,1003,1004 may be made of an electrical insulator material such as plastic, silicon nitride (Si₃N₄), Zirconia (ZRO₂), silicon carbide (Sic), or polyether ether ketones. In other embodiments of the invention, without limitation, the balls may be metal, wood, stainless steel, or combinations thereof. Similarly, the Plunger Nose 8013 and/or the Plunger Body 8020 may include, without limitation, an electrical insulator, plastic, metal, wood, stainless steel, or combinations thereof.

The support surfaces are shown in the figures with right-angle orientations relative to vertical axes (centerlines) of the holders and the electrodes. In the right-angle orientation, the planes of the rings comprising the supporting surfaces are oriented 90 degrees relative to the vertical axes and face each other. The rings may support the welding machine workpiece clamping force and they may improve transfer of heat and electricity between the electrode and the holder. But the supporting surfaces do not have to include rings and they do not need 90 degrees orientations. Without limitation, the support surfaces may include shapes which are conical, ring, curved, flat, bowed, with taper, without taper, oriented at other angles, configured as self-releasing, or combinations thereof.

In operation, the support surfaces may form the secondary electrical connection between electrode and holder, while the primary electrical connection is formed by the flexible member and the pressure element. After many changes of the electrode, the flexible member may become worn. The physical wear may decrease the effectiveness of the primary electrical connection, increasing its resistance. Arcing or sparking in the holder may occur if not for the secondary electrical connection carrying a greater of portion the welding current. In a fault mode characterized by extreme wear, the primary electrical connection may fail completely and be supplanted by the secondary electrical connection.

FIGS. 6 and 7 show the O-ring for preventing coolant leakage. The O-ring may be replaced by a different elastomeric element. This may include, without limitation, an O-ring, a seal ring, a bonded seal washer, a gasket, a wax seal, a rubber seal, a pressure seal, a hydraulic seal, a piston seal, a rod seal, a wiper seal, a symmetric seal, an asymmetric seal, a stretchy seal, a polyurethane seal, an oil seal, a PTFE seal, a nylon seal, a face seal, and/or an edge seal, or combinations thereof.

The outer diametrical surface of any electrode disclosed herein may include a knurl to facilitate removing the electrode from the holder with tools or bare hands. Such a knurl may be like the Knurl 8015 shown on various short holders.

In some of the embodiments the electrodes and the holders are round shaped (circular, rounded, cylindrical, or conical). Round shape may be manufacturable or economical. But round is not required. Without limitation, other geometric shapes may be employed such as, square, rectangle, oval, obround, polygon, parallelogram, rhombus, trapezoid, or combinations thereof.

The present invention may be incorporated into a variety of products. Without limitation these may include, resistance welding products, straight tips, caps and shanks, bent electrodes, double bend tips, flattened tips, special tips, class alloy tips, backup electrodes and holders, swivel tips, refractory metal-faced tips, holders for threaded electrodes, electrode adapters, cylinder-mounted holders, straight holders, offset holders, welder arms, variable-offset holders, paddle-type holders, platen-mounted holders, high-pressure electrodes and holders, nut welding electrodes and holders, stud welding electrodes, or combinations thereof.

The present invention may be incorporated into a variety of welding processes. Without limitation these may include resistant welding, spot welding, projection welding, butt welding, flash butt welding, seam welding, low-frequency welding, flash welding, robotic welding, or combinations thereof.

The present invention may be configured for carrying welding current to a remote electrode and/or holder. The primary electrical connection may be configured for connecting wires and/or busses. The quick-release mechanisms or latch may include a lock and key to deter accidental disconnection or mischief.

Two examples of the spring latch are provided above. One includes the balls with the corresponding notch. The other includes the spring-loaded plunger with the receiving hole. Without limitation, other types of spring latches may be utilized such as latch bolt, spring-loaded bolt with an angled edge, deadlocking latch bolt, slam latch, push-button latch, slide spring draw latch, ball-lock retainer, ball and spring, ball and spring with teardrop notch, or combinations thereof.

The spring latch examples above have compression springs. Activation of the latches may be accomplished by displacing the springs through compression. Other spring types may be utilized. Without limitation these include extension spring, torsion spring, constant force spring, spring washer, drawbar spring, volute spring, flat spring, garter spring, gas spring, air spring, elastomer spring, urethane spring, or combinations thereof. Without limitation, the spring displacement may occur through compression, extension, rotation, flexure, torsion, pressure, or combinations thereof.

Examples of mechanical latches are provided in the figures above. Other latch types may be utilized. Without limitation, these include twist latch, a t-handle latch, overcenter latch, toggle latch, cam latch, slide bolt latch, compression latch, swell latch, draw latch, premium draw latch, sliding latch, sliding snap latch, adjustable latch, or combinations thereof.

The features disclosed in this specification may be replaced by alternative features serving the same, equivalent, or similar purpose, unless stated otherwise. This includes the accompanying abstracts and drawings. Unless stated otherwise, each feature disclosed is an example one generic series of equivalent or similar features.

Having fully described several embodiments of the present invention, other equivalent or alternative methods of implementing electrodes and holders in accordance with the invention will be apparent to those skilled in the art. Various aspects of the invention are described above with illustrations. The embodiments disclosed are not intended to limit the invention to the forms disclosed. The implementations of the electrodes and holders may vary depending upon context or application.

By examples, and not limitation, the electrodes and holders described in the foregoing were principally directed to resistance welding implementations. Similar practices may instead be applied to other welding systems where decreased maintenance downtime is desirable, which implementations are contemplated as within the scope of the present invention. The invention is to cover modifications, equivalents, and alternatives falling within the spirit and scope of the following claims. It is to be further understood that not all the disclosed embodiments in the foregoing specification will necessarily satisfy or achieve each of the objects, advantages, or improvements described in the foregoing specification.

The description of the present invention is not intended to be exhaustive or limited to the invention in the forms disclosed. Many modifications and variations will be apparent to those of ordinary skill in the art without departing from the scope and spirit of the invention. The embodiments were chosen and described to explain the principles of operation and practical application, and to enable others of ordinary skill in the art to understand the invention for various embodiments with various modifications as are suited to the contemplated use.

Claim elements and steps herein may have been numbered and/or lettered solely to assist readability and understanding. The numbering and lettering is not intended to and should not be taken to indicate an ordering of elements and/or steps in the claims.

The Abstract is provided to comply with 37 C.F.R. Section 1.72(b) requiring an abstract that will allow the reader to ascertain the nature the disclosure. It is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. An apparatus comprising:
a) a workpiece;
b) an electrode being configured for at least a physical contact with the workpiece;
c) a holder being configured for at least a physical contact with the electrode;
d) a welding current being configured for at least heating the workpiece to form a weld nugget;
e) an extracting force being configured for at least withdrawing the electrode from the workpiece after formation of the weld nugget;
f) a primary electrical connection of the electrode and the holder being configured for carrying at least a portion of the welding current;
g) the primary electrical connection having at least one flexible member being in physical contact with at least one pressure element, the flexible member being flexed by at least the pressure element; and
h) the primary electrical connection insufficiently binding the electrode to the holder for the extracting force withdrawing the electrode from the workpiece after formation of the weld nugget.

2. The apparatus as recited in claim 1, further comprising a latch being configured for at least binding the electrode to the holder to enable the extracting force withdrawing the electrode from the workpiece after formation of the weld nugget.

3. The apparatus as recited in claim 2, in which the latch further comprises a looseness or slack being configured for at least allowing the electrode to move relative to the holder in a normal mode of operation.

4. The apparatus as recited in claim 2, in which the latch further comprises a spring being configured for at least enabling removal of the electrode from the holder in response to a displacement of the spring.

5. The apparatus as recited in claim 1, further comprising:
a) a secondary electrical connection of the electrode and the holder being configured for carrying at least another portion of the welding current, the secondary electrical connection being self-releasing;
b) a workpiece clamping force being configured for at least clamping the electrode to the workpiece during formation of the weld nugget; and
c) a normal mode of operation comprising at least the workpiece clamping force enabling the secondary electrical connection.

6. An apparatus comprising:
a) a welding current being configured for at least heating a workpiece to form a weld nugget;
b) a secondary electrical connection being configured for carrying at least a portion of the welding current, the secondary electrical connection being self-releasing;
c) the secondary electrical connection comprising at least a first surface facing a second surface, the workpiece comprising neither the first surface nor the second surface;
d) a workpiece clamping force being configured for at least clamping the workpiece during formation of the weld nugget; and
e) a normal mode of operation comprising at least the workpiece clamping force bringing the first surface into physical contact with the second surface to enable the secondary electrical connection.

7. The apparatus as recited in claim 6, further comprising:
a) an electrode being configured for at least a physical contact with the workpiece;
b) a holder being configured for at least a physical contact with the electrode;
c) an extracting force being configured for at least withdrawing the electrode from the workpiece after formation of the weld nugget; and
d) a latch being configured for at least binding the electrode to the holder to enable the extracting force withdrawing the electrode from the workpiece after formation of the weld nugget.

8. The apparatus as recited in claim 7, in which the latch further comprises a looseness or slack being configured for at least allowing the electrode to move relative to the holder in a normal mode of operation.

9. The apparatus as recited in claim 7, in which the latch further comprises a spring being configured for at least enabling removal of the electrode from the holder in response to a displacement of the spring.

10. The apparatus as recited in claim 6, further comprising:
a) an electrode being configured for at least a physical contact with the workpiece;
b) a holder being configured for at least a physical contact with the electrode;
c) an extracting force being configured for at least withdrawing the electrode from the workpiece after formation of the weld nugget;
d) a primary electrical connection of the electrode and the holder being configured for carrying at least another portion of the welding current;
e) the primary electrical connection having at least one flexible member being in physical contact with at least one pressure element, the flexible member being flexed by at least the pressure element; and
f) the primary electrical connection insufficiently binding the electrode to the holder for the extracting force withdrawing the electrode from the workpiece after formation of the weld nugget.

11. An apparatus comprising:
a) a workpiece;
b) a welding electrode being configured for at least a physical contact with the workpiece;
c) a holder being configure for at least supporting the welding electrode;
d) a latch being configured for at least preventing unintentional dislodgement of the welding electrode from the holder; and
e) the latch having a looseness or slack being configured for at least allowing the welding electrode to move relative to the holder in a normal mode of operation.

12. The apparatus as recited in claim 11, in which the latch further comprises a spring being configured for at least enabling removal of the welding electrode from the holder in response to a displacement of the spring.

13. The apparatus as recited in claim 11, in which the spring further comprises at least one mechanical latch selected from the group consisting of:
a) a bulge and a locking device;
b) a hole and a locking device;
c) a setscrew and a receiving hole;
d) a threaded coupling, external threads, a setscrew, and a threaded hole; and
e) a rotation-resistant device configured for at least preventing rotation of the welding electrode relative to the holder.

14. The apparatus as recited in claim 11, further comprising:
a) a welding current being configured for at least heating the workpiece to form a weld nugget;
b) the welding electrode having the physical contact with the workpiece during at least formation of the weld nugget;
c) a primary electrical connection being configured for carrying at least a portion of the welding current;
d) the primary electrical connection having at least one flexible member being in physical contact with at least one pressure element, the flexible member being flexed by at least the pressure element; and
e) the primary electrical connection insufficiently binding the welding electrode to the holder for withdrawing the welding electrode from the workpiece.

15. The apparatus as recited in claim 11, further comprising:
a) a welding current being configured for at least heating the workpiece to form a weld nugget;
b) the welding electrode having the physical contact with the workpiece during at least formation of the weld nugget;
c) a secondary electrical connection being configured for carrying at least a portion of the welding current, the secondary electrical connection being self-releasing;
d) a workpiece clamping force being configured for at least clamping the welding electrode to the workpiece during formation of the weld nugget; and
e) the normal mode of operation further comprising at least the workpiece clamping force enabling the secondary electrical connection.

16. An apparatus comprising:
a) a workpiece;
b) a welding electrode being configured for at least a physical contact with the workpiece;
c) a holder being configure for at least supporting the welding electrode;
d) a spring latch being configured for at least preventing unintentional dislodgement of the welding electrode from the holder; and
e) the spring latch having a spring being configured for at least enabling removal of the welding electrode from the holder in response to a displacement of the spring.

17. The apparatus as recited in claim 16, in which the spring latch further comprises a looseness or slack being configured for at least allowing the welding electrode to move relative to the holder in a normal mode of operation.

18. The apparatus as recited in claim 16, in which the spring latch further comprises at least one quick-release mechanism selected from the group consisting of:
a) a plunger nose and a receiving hole;
b) a retaining groove and at least one ball, and;
c) a rotation-resistant device configured for at least preventing rotation of the welding electrode relative to the holder.

19. The apparatus as recited in claim 16, further comprising:
a) a welding current being configured for at least heating the workpiece to form a weld nugget;
b) the welding electrode having the physical contact with the workpiece during at least formation of the weld nugget;
c) a primary electrical connection being configured for carrying at least a portion of the welding current;
d) the primary electrical connection having at least one flexible member being in physical contact with at least one pressure element, the flexible member being flexed by at least the pressure element; and
e) the primary electrical connection insufficiently binding the welding electrode to the holder for withdrawing the welding electrode from the workpiece.

20. The apparatus as recited in claim 16, further comprising:
a) a welding current being configured for at least heating the workpiece to form a weld nugget;
b) the welding electrode having the physical contact with the workpiece during at least formation of the weld nugget;
c) a secondary electrical connection being configured for carrying at least a portion of the welding current, the secondary electrical connection being self-releasing;
d) a workpiece clamping force being configured for at least clamping the welding electrode to the workpiece during formation of the weld nugget; and
e) a normal mode of operation comprising at least the workpiece clamping force enabling the secondary electrical connection.
